(19) United States
(12) Patent Application Publication
(10) Pub. No.: US 2013/0315788 A1
(43) Pub. Date: Nov. 28, 2013

(54) CATALYTIC CONVERTER

(71) Applicants: DENSO CORPORATION, Kariya-shi (JP); TOYOTA JIDOSHA KABUSHIKI KAISHA, Toyota-shi (JP)

(72) Inventors: Hiromasa SUZUKI, Toyota-shi (JP); Michiharu NAKANO, Toyota-shi (JP); Masaru KAKINOHANA, Toyota-shi (JP); Hiroyuki MATSUBARA, Gifu-shi (JP); Masakazu MURATA, Obu-shi (JP); Naohiro HAYASHI, Kariya-shi (JP)

(73) Assignees: DENSO CORPORATION, Kariya-shi (JP); TOYOTA JIDOSHA KABUSHIKI KAISHA, Toyota-shi (JP)

(21) Appl. No.: 13/897,764

(22) Filed: May 20, 2013

(30) Foreign Application Priority Data
May 24, 2012 (JP) 2012-118519

(51) Int. Cl. B01D 53/94

(52) U.S. Cl. CPC B01D 53/94
USPC 422/168

(57) ABSTRACT

A catalytic converter has a carrier with a cell structure, and a precious metal catalyst carried on the carrier. The carrier includes a first carrier and a second carrier. The second carrier is provided downstream of the first carrier in a gas flow direction of gas that flows into the catalytic converter. The first carrier has a first peripheral region and a first center region that has a lower cell density than the first peripheral region. The second carrier has a second center region and a second peripheral region that has a lower cell density than the second center region.

The disclosure of Japanese Patent Application No. 2012-118519 filed on May 24, 2012 including the specification, drawings and abstract is incorporated herein by reference in its entirety.

### BACKGROUND OF THE INVENTION

1. Field of the Invention

The invention relates to a catalytic converter provided in a conduit that forms an exhaust system for exhaust gas.

2. Description of Related Art

In various industrial fields, various efforts to reduce environment impact are being made on a global scale. Of these, in the automotive industry, in addition to a development of gasoline engine vehicles with sufficient fuel efficiency performance, so-called eco-cars (ecologically-friendly cars) such as hybrid vehicles and electric vehicles are being popularized, and developments are being made to further improve the performance of these vehicles.

Typically, a catalytic converter for purifying exhaust gas is arranged in an exhaust system for exhaust gas that connects a vehicle engine to a muffler.

The engine may discharge toxic substances to the environment, such as CO, NOx, unburned HC, and volatile organic compounds (VOC) and the like. These toxic substances are converted into acceptable substances by passing the exhaust gas through the catalytic converter. That is, CO is transformed into CO₂, NOx is transformed into N₂ and O₂, and VOC is combusted to produce CO₂ and H₂O. The catalytic converter has a hollow substrate, and a ceramic structure or the like that is covered by a metal catalyst such as palladium or platinum is provided inside of this hollow substrate.

A catalytic converter according to related art has a carrier CA formed by carriers C1 and C2 that are cell structures, inside of a substrate K that forms a conduit system, as shown in FIG. 6. The carrier C1 is provided upstream (i.e., on a front side (Fr side) of the substrate) in the direction in which exhaust gas flows (hereinafter simply referred to as the “exhaust gas flow direction”), and the carrier C2 is provided downstream (i.e., on a rear side (Rr side) of the substrate) in the exhaust gas flow direction. A precious metal is carried on the carrier CA. In this catalytic converter, the cell densities of the carriers C1 and C2 are typically the same.

Japanese Patent Application Publication No. 9-317454 (JP 9-317454 A) describes a catalytic converter that in which the carrier of the catalytic converter of the related art shown in FIG. 6 is improved by making the flow rate distribution and the temperature distribution of the overall catalytic converter uniform. In the catalytic converter described in JP 9-317454 A, the cell density is different at a center region than it is at a peripheral region in both the upstream carrier and the downstream carrier in the gas flow direction.

FIG. 7 is a view simulating the catalytic converter described in JP 9-317454 A. In the catalytic converter illustrated in FIG. 7, in an upstream carrier C1, the cell density at a center region C1a is higher than that of a peripheral region C1b. Also, in a downstream carrier C2, in contradiction to the carrier C1, the cell density of a peripheral region C2b is higher than that of a center region C2a.

With the catalytic converter provided with the carriers C1 and C2 having these kinds of cell densities, exhaust gas that flows in direction X1 and enters the catalytic converter mainly flows (in direction X1′) through the peripheral region C1b where the cell density of the upstream carrier C1 is low and gas flows easily. Then in the downstream carrier C2, the exhaust gas mainly flows through the center region C2a where the cell density is low and gas flows easily.

Gas typically flows through a conduit at a relatively high flow rate at a center portion of the conduit where it is not affected by friction with the wall surface of the conduit. Therefore, the exhaust gas tends to flow easily through this center region in the catalytic converter as well. However, if the cell density of the center region of the upstream catalyst into which the exhaust gas that has entered the catalytic converter first flows is large, as is shown in FIG. 7, pressure loss with respect to the exhaust gas flow will increase. As a result, with the catalytic converter shown in FIG. 7, the exhaust gas will not flow as easily, so the amount of exhaust gas that flows in may end up decreasing.

If the amount of exhaust gas that flows into the catalytic converter decreases in this way, the supply of heat to the catalytic converter will also naturally decrease, and the warm-up capability immediately after engine startup will decrease. With this decrease in warm-up capability immediately after engine startup, the emission (i.e., cold emission) of HC and NOx and the like may be promoted.

### SUMMARY OF THE INVENTION

The invention thus provides a catalytic converter that has sufficient warm-up capability immediately after engine startup, and moreover, has high exhaust gas purifying performance by the entire catalyst being effectively utilized.

One aspect of the invention relates to a catalytic converter that has a carrier with a cell structure, and a precious metal catalyst carried on the carrier. The carrier includes a first carrier and a second carrier. The second carrier is provided downstream of the first carrier in a gas flow direction of gas that flows into the catalytic converter. The first carrier has a first peripheral region and a first center region that has a lower cell density than the first peripheral region. The second carrier has a second center region and a second peripheral region that has a lower cell density than the second center region.

The catalytic converter of the aspect of the invention described above includes the first carrier and the second carrier that each have a cell structure, in order from upstream in the exhaust gas flow direction. Also, in the catalytic converter of the aspect of the invention described above, the first carrier and the second carrier have cell densities opposite those of the catalytic converter shown in FIG. 7. That is, in the first carrier that is positioned upstream, the cell density of the first peripheral region is higher than the cell density of the first center region, and in the second carrier that is positioned downstream, the cell density of the second center region is higher than the cell density of the second peripheral region. In this structure, exhaust gas that has flowed into the catalytic converter first flows into the upstream first carrier. The cell density of the first center region of the upstream first carrier is lower than that of the first peripheral region, so pressure loss with respect to the exhaust gas flow is relatively low. Therefore, the exhaust gas flows easily through the first center region of the first carrier, so the amount of exhaust gas that flows in increases. This increase in the amount of the exhaust gas that flows in promotes the supply of heat to the catalytic converter, so the warm-up capability immediately after engine startup increases. As a result, with this increase in warm-up capability immediately after engine startup, the emission (cold emission) of HC and NOx and the like is effectively suppressed.

Also, the exhaust gas that has passed through the first center region of the first carrier flows mainly through the second peripheral region where the cell density and pressure loss are low, in the second carrier that is positioned downstream. In this way, in the second carrier that is positioned downstream, the exhaust gas flow is promoted in the second peripheral region. As a result, the exhaust gas flow distribution that is larger at the first center region of the upstream first carrier is distributed to the second peripheral region in the downstream second carrier. Therefore, when the carrier is viewed as a whole, the exhaust gas flow distribution is rectified to a flow distribution that is as uniform as possible. This kind of exhaust gas flow distribution rectifying action by the second carrier enables the precious metal catalyst of the entire carrier to be effectively utilized, such that a catalytic converter having high exhaust gas purifying performance is able to be obtained.

According to the catalytic converter of this aspect of the invention, the amount of exhaust gas that flows therein increases, so the supply of heat to the catalytic converter is promoted. Therefore, the cold emission reduction effect is increased with the improvement in the warm-up capability immediately after engine startup. Furthermore, the exhaust gas flow distribution that increases at the center region of the upstream first carrier is distributed to the peripheral region in the downstream second carrier, so the exhaust gas flow distribution is rectified to as uniform a flow distribution as possible. Accordingly, the precious metal catalyst of the entire carrier is effectively utilized, so the exhaust gas purifying performance improves.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing a frame format of an exhaust system for exhaust gas, in which a catalytic converter according to one example embodiment of the invention is interposed;

FIG. 2 is a view showing a frame format of the catalytic converter according to the example embodiment of the invention;

FIG. 3 is a view of test results related to a cold emission ratio and a cell density ratio of a center region and a peripheral region of an upstream carrier;

FIG. 4 is a view of test results related to the cold emission ratio and a ratio of a radius of the center region to a radius of a peripheral region of first and second carriers;

FIGS. 5A and 5B are views of test results related to the cold emission ratio and the cell density ratio of the center region and the peripheral region of an upstream carrier, and test results related to the cold emission ratio and the ratio of the radius of the center region to the radius of the peripheral region of the first and second carriers;

FIG. 6 is a view showing a frame format of a catalytic converter according to related art; and

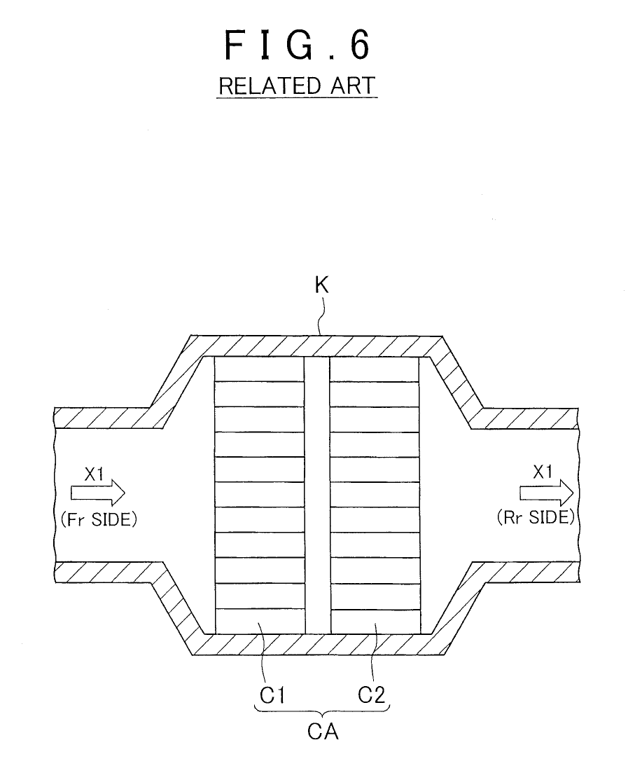

FIG. 7 is another view showing a frame format of the catalytic converter according to the related art.

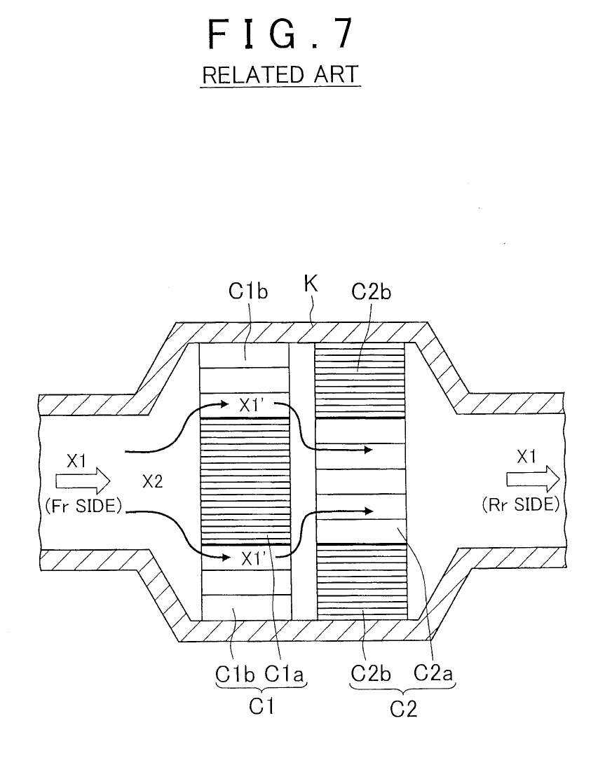

### DETAILED DESCRIPTION OF EMBODIMENTS

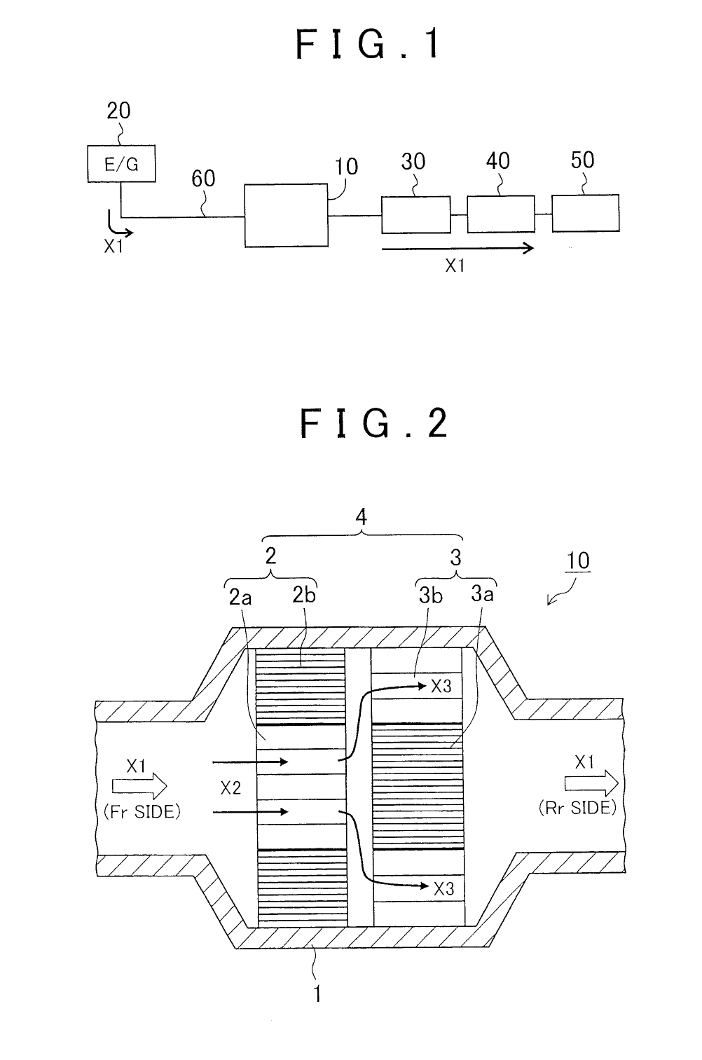

Hereinafter, example embodiments of a catalytic converter of the invention will be described with reference to the accompanying drawings. FIG. 1 is a view showing a frame format of an exhaust system for exhaust gas, in which a catalytic converter according to one example embodiment of the invention is interposed.

The exhaust system for exhaust gas includes an engine 20, a catalytic converter 10, a three-way catalytic converter 30, sub muffler 40, and a main muffler 50. The engine 20 and the catalytic converter 10 are connected by a system conduit 60. Similarly, the catalytic converter 10 is connected to the three-way catalytic converter 30, the three-way catalytic converter 30 is connected to the sub muffler 40, and the sub muffler 40 is connected to the main muffler 50, all via the system conduit 60. That is, the engine 20 is connected to an upstream portion of the catalytic converter 10 via the system conduit 60. Exhaust gas produced by the engine 20 is discharged in direction X1 in FIG. 1. In the exhaust system shown in FIG. 1, the catalytic converter 10 may be an electrically heated catalytic converter (EHC). This electrically heated catalytic converter has a honeycomb catalyst. In the electrically heated catalytic converter, a pair of electrodes is attached to the honeycomb catalyst, for example. The honeycomb catalyst is heated by flowing current through these electrodes, thus increasing the activity of the honeycomb catalyst, which detoxifies exhaust gas that passes through the converter. In addition to purifying exhaust gas at normal temperatures, the electrically heated catalytic converter also purifies exhaust gas during a cold start by activating the catalyst through electric heating. For example, when starting the engine 20, the honeycomb catalyst is heated so that its temperature rises to a predetermined temperature as quickly as possible, and the exhaust gas that flows from the engine is purified by this honeycomb catalyst. Also, exhaust gas that has not been completely purified by the electrically heated catalytic converter is purified by the three-way catalytic converter 30 positioned downstream in the gas flow direction.

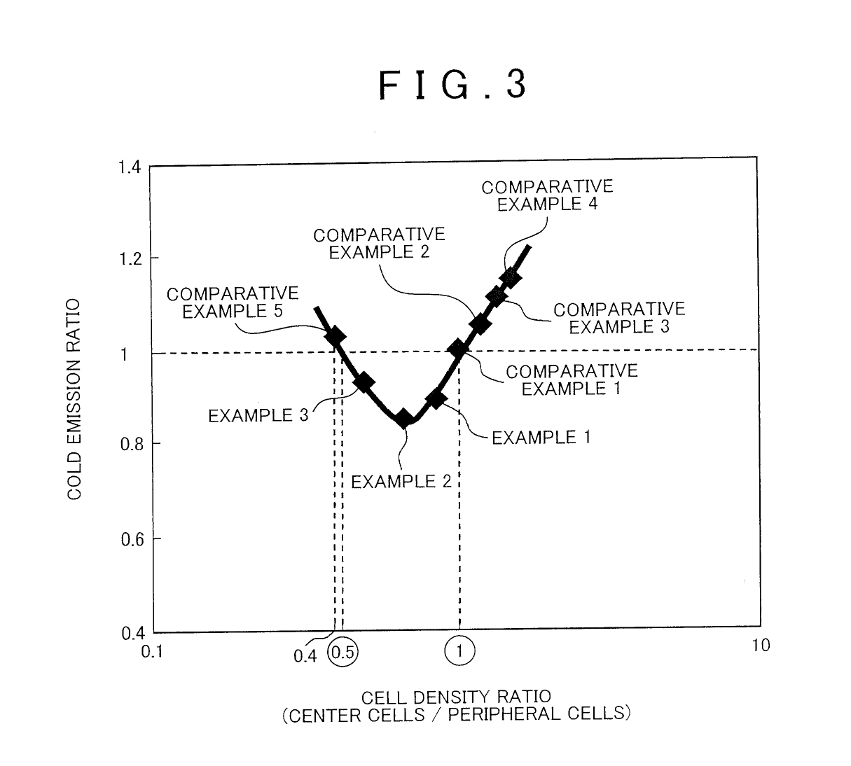

Next, the catalytic converter according to the example embodiment will be described. FIG. 2 is a view of the catalytic converter according to the example embodiment of the invention. The catalytic converter 10 shown in FIG. 2 includes a cylindrical substrate 1 that is hollow, and a carrier 4 that carries a precious metal catalyst housed in the substrate 1. Hereinafter, the carrier 4 may also be referred to as “honeycomb catalyst carrier 4”. Also, as shown in FIG. 2, the radius of a cross-section of the honeycomb catalyst carrier 4 in a direction orthogonal to the gas flow direction is larger than a radius of a cross-section of the system conduit 60 in the same direction.

Here, as the material of the substrate 1, ceramic material such as cordierite or silicon carbide may be used, or material other than ceramic material, such as metal material, may be used. Cordierite is a complex oxide of magnesium oxide, aluminum oxide, and silicon dioxide. Also, the substrate 1 may be a hollow body that has a circular cylindrical shape, or a polyangular shape with a rectangular cross-section or the like.

Also, the honeycomb catalyst carrier 4 that is housed in the substrate 1 is made of cordierite, silicon oxide, or a conductive metal such as a stainless metal or the like. Also, the honeycomb catalyst carrier 4 has multiple lattice sections that are square or hexagonal in shape. If a cordierite honeycomb carrier using cordierite is used for the honeycomb catalyst carrier 4, the thermal shock resistance will improve. The honeycomb catalyst carrier 4 carries a dispersed catalyst metal such as platinum, palladium, or rhodium.

Gas flow holes through which exhaust gas flows are formed in the center of the lattice of the honeycomb catalyst carrier 4.

The honeycomb catalyst carrier 4 includes a first carrier 2 positioned upstream (on the Fr side) in the exhaust gas flow direction, and a second carrier 3 positioned downstream (on the Rr side) in the exhaust gas flow direction. That is, the second carrier 3 is provided downstream of the first carrier 2 in a gas flow direction of gas that flows into the catalytic converter 10. Hereinafter, unless otherwise specified, the terms upstream and downstream will refer to upstream and downstream, respectively, in the direction in which gas (i.e., exhaust gas) flows (i.e., the gas flow direction). The first carrier 2 and the second carrier 3 are provided lined up in the gas flow direction. The first carrier 2 and the second carrier 3 are both circular cylindrical bodies having circular cross-sections in a direction orthogonal to the gas flow direction. The inside of the first carrier 2 and the inside of the second carrier 3 is formed by multiple cells. Furthermore, the first carrier 2 and the second carrier 3 are provided either contacting each other in the gas flow direction, or slightly separated from each other in the gas flow direction. A precious metal catalyst is carried on the first carrier 2 and the second carrier 3. Here, in the first carrier 2 positioned upstream, the cell density of a peripheral region 2b is higher than that of a center region 2a. On the other hand, in the second carrier 3 positioned downstream, the cell density of a center region 3a is higher than that of a peripheral region 3b. Here, the center region 2a may be regarded as a first center region of the invention, and the peripheral region 2b may be regarded as a first peripheral region of the invention. Also, the peripheral region 3b may be regarded as a second peripheral region of the invention, and the center region 3a may be regarded as a second center region of the invention.

According to the structure of the illustrated carriers, exhaust gas in the catalytic converter 10 first flows into the upstream first carrier 2. The cell density of the center region 2a of the upstream first carrier 2 is lower than the cell density of the peripheral region 2b, so pressure loss with respect to the exhaust gas flow is low. Therefore, the exhaust gas flows easily through the center region 2a of the first carrier 2 (exhaust gas flow X2 in FIG. 2), such that the amount of exhaust gas that flows in is large compared with the related art. This increase in the amount of the exhaust gas that flows in promotes the supply of heat to the catalytic converter 10, so the warm-up capability immediately after engine startup increases. Also, with this increase in warm-up capability immediately after engine startup, the cold emission of HC and NOx and the like is effectively suppressed.

Also, the exhaust gas that has passed through the center region 2a of the first carrier 2 flows mainly through the peripheral region 3b where the cell density and pressure loss are lower than they are in the center region 3a (exhaust gas flow X3 in FIG. 2), in the second carrier 3 that is positioned downstream. In this way, in the second carrier 3 that is positioned downstream, the exhaust gas flow is promoted in the peripheral region 3b thereof, and as a result, the exhaust gas flow distribution that is larger at the center region 2a of the upstream first carrier 2 is distributed to the peripheral region 3b in the downstream second carrier 3. Therefore, when the carrier is viewed as a whole, the exhaust gas flow distribution is rectified to an exhaust gas flow distribution that is as uniform as possible. This kind of exhaust gas flow distribution rectifying action by the second carrier 3 enables the precious metal catalyst of the entire carrier 4 to be effectively utilized, such that a catalytic converter having high exhaust gas purifying performance is able to be obtained.

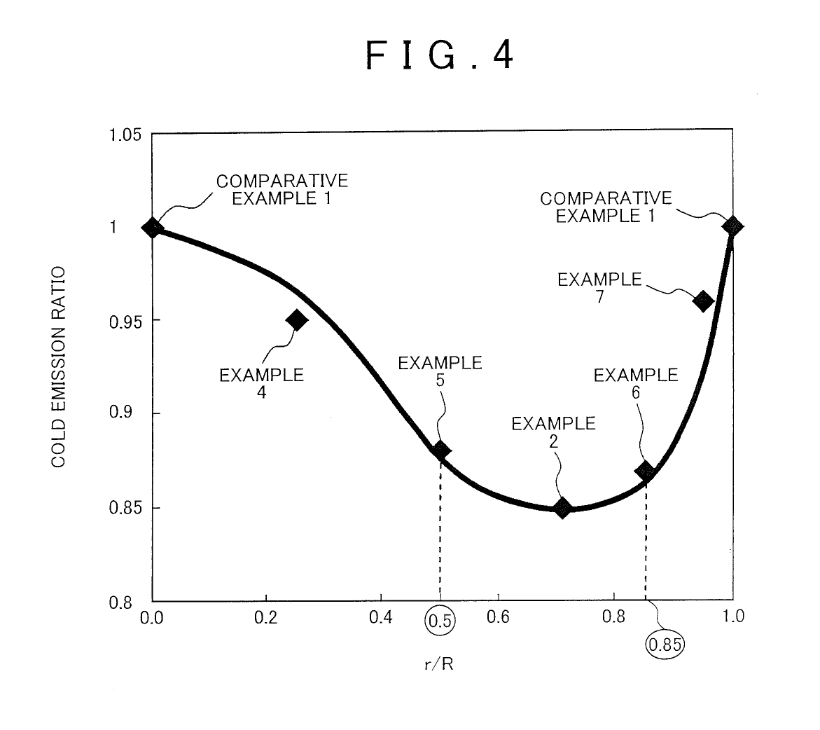

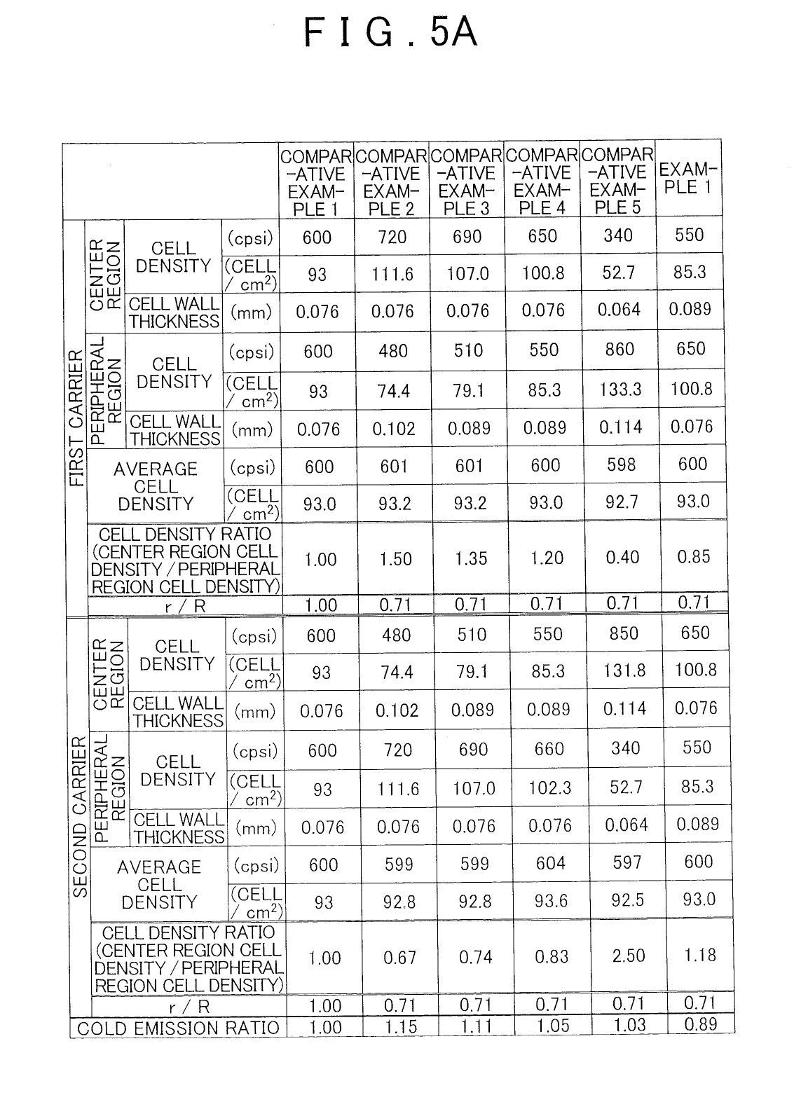

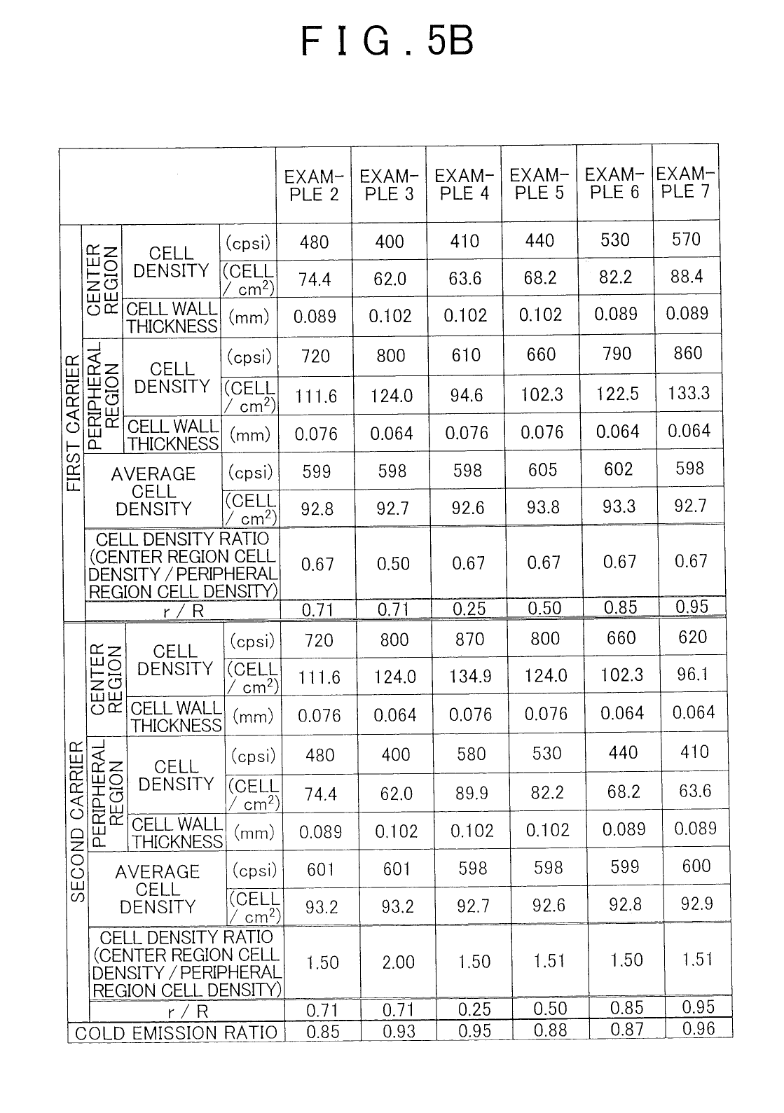

FIGS. 5A and 5B are views of test results related to the cold emission ratio and the cell density ratio of the center region and the peripheral region of the upstream carrier, and test results related to the cold emission ratio and the ratio of the radius of the center region to the radius of the peripheral region of the first and second carriers. In the test, catalytic converters of Comparative examples 1 to 5 and Examples 1 to 7 were manufactured according to the various specifications shown in FIGS. 5A and 5B. Then a test was conducted to identify the relationship between the cold emission ratio and the cell density ratio of the center region and the peripheral region of the upstream catalyst, and the relationship between the emission ratio and the ratio of the radius of the center region to the radius of the peripheral region of the first and second carriers. Here, the term “cold emission” is the emission of HC+NOx immediately after engine startup. The term “cold emission ratio” is the ratio of the actual measured value of each catalytic converter to the actual measured value of Comparative example 1. The catalyst has a diameter φ of 103 mm and a length L of 105 mm. The cold emission ratio is shown in the bottom column of FIGS. 5A and 5B. FIG. 3 is a view of the test results related to the cold emission ratio and the cell density ratio, and FIG. 4 is a view of the test results related to the relationship between the cold emission ratio and the ratio of the radius of the center region to the radius of the peripheral region of the first and second carriers. Here, the radius of the center region is denoted by “r”, and the radius of the peripheral region is denoted by “R”. In Comparative example 1, the cell densities of the center region and the peripheral region are the same, so r/R may be both 0 and 1. Therefore, r/R in Comparative example 1 is shown at a value of both 0 and 1. In FIGS. 5A and 5B, “cpsi” means a number of cells per square inch.

FIGS. 5A, 5B, and 3 verify that when the cell density ratio of the center region and the peripheral region of the upstream carrier of each of the Examples is in a range equal to or greater than 0.5 and less than 1, the cold emission ratio is less than 1. That is, in the upstream carrier (i.e., the first carrier), when the ratio of the cell density of the (first) center region to the (first) peripheral region is within a range equal to or greater than 0.5 and less than 1, a cold emission reducing effect (i.e., the emission reducing effect on HC and NOx and the like immediately after engine startup) increases. From this test result, it may be determined that the desirable range of the cell density ratio of the center region and the peripheral region of the upstream carrier of the honeycomb catalyst carrier is a range equal to or greater than 0.5 and less than 1.

Also, from FIGS. 5A, 5B, and 4, the cold emission ratios of the Examples are all equal to or less than 1. This verifies that it is preferable to have a structure in which the first carrier that is positioned upstream has a higher cell density in the peripheral region than in the center region, and the second carrier that is positioned downstream has a higher cell density in the center region than in the peripheral region, regardless of the ratio of the radius of the center region and the radius of the peripheral region of the carrier. Moreover, from these drawings, it can be determined that the preferable range of r/R is a range equal to or greater than 0.5 and equal to or less than 0.85, because one of the inflection points of an approximate curve that passes through each plot is shown when r/R is 0.5 or 0.85, and the cold emission ratio assumes the lowest value near 0.85 within the range between 0.5 and 0.85. That is, when r/R is equal to or greater than 0.5 and equal to or less than 0.85, the cold emission reducing effect increases.

While the invention has been described with reference to various example embodiments thereof, the specific structure is not limited to these example embodiments. That is, the invention also includes any and all design changes and other variations and modifications and the like within the scope of the invention.

What is claimed is:

1. A catalytic converter comprising:
a carrier with a cell structure, the carrier including a first carrier and a second carrier, the second carrier being provided downstream of the first carrier in a gas flow direction of gas that flows into the catalytic converter; and
a precious metal catalyst carried on the carrier, wherein:
the first carrier has a first peripheral region and a first center region that has a lower cell density than the first peripheral region; and
the second carrier has a second center region and a second peripheral region that has a lower cell density than the second center region.

2. The catalytic converter according to claim 1, wherein
the first carrier and the second carrier are provided lined up in the gas flow direction.

3. The catalytic converter according to claim 2, wherein
a ratio of a cell density of the first center region to a cell density of the first peripheral region is equal to or greater than 0.5 and less than 1.

4. The catalytic converter according to claim 1, wherein
the first carrier is a circular cylindrical body having a circular cross-section in a direction orthogonal to the gas flow direction;
the second carrier is a circular cylindrical body having a circular cross-section in the direction orthogonal to the gas flow direction;
a value obtained by dividing a radius of the first center region by a radius of the first peripheral region is equal to or greater than 0.5 and equal to or less than 0.85; and
a value obtained by dividing a radius of the second center region by a radius of the second peripheral region is equal to or greater than 0.5 and equal to or less than 0.85.

5. The catalytic converter according to claim 4, further comprising
a cylindrical substrate that is hollow,
wherein the carrier is housed in the cylindrical substrate;
the catalytic converter is connected to an engine via a system conduit; and
a radius of a cross-section of the carrier is larger than a radius of a cross-section of the system conduit, in the direction orthogonal to the gas flow direction.

6. The catalytic converter according to claim 1, wherein
an engine is connected via a system conduit to an upstream portion of the catalytic converter, in the gas flow direction.
